(19) United States
(12) Patent Application Publication
(10) Pub. No.: US 2010/0011135 A1
(43) Pub. Date: Jan. 14, 2010

(54) SYNCHRONIZATION OF REAL-TIME MEDIA PLAYBACK STATUS

(75) Inventors: Amandeep Jawa, San Francisco, CA (US); Alan Cannistraro, San Francisco, CA (US); Daniel Davis, San Francisco, CA (US)

Correspondence Address: Apple Inc.;c/o Novak Druce + Quigg LLP, 1000 Louisiana Street, Fifty-Third Floor, Houston, TX, 77002, US

(73) Assignee: Apple Inc., Cupertino, CA (US)

(21) Appl. No.: 12/171,293

(22) Filed: Jul. 10, 2008

(51) Int. Cl. G06F 3/00

(52) U.S. Cl. 710/19

(57) ABSTRACT

In a system comprising a content performance device, multiple status display devices can communicate with the performance device to receive messages updating status of content being performed by the performance device, or being transmitted to one or more other performance devices. Content performance devices can include computers configured with software for managing media libraries, for obtaining Internet-based media, as well as more purpose-specific devices, such as digital video recorders, settop boxes, Apple TV, TiVo, and so on. Status display devices, remote controls or client devices can make standing requests to receive status updates as status changes. Status display devices also can function as remote controls for the performance device, and can submit control requests to it, which when effected, are acknowledged to all status display devices, which responsively update their displays. Each status display device can interpret content sent for communicating status updates, and can make changes to a respective display, or to other features or functions according to its programming. Status display devices can include personal information managers, smart phones, laptops, palm tops and other electronic devices capable of displaying playback status information received from the content performance device.

### RELATED APPLICATIONS

The present application is related to U.S. Pat. No. 6,728,729, the content of which are incorporated herein by reference. The present application is also related to Apple Docket Nos. P5929US1 and P5928US1. The content of each of these applications is incorporated herein by reference.

### BACKGROUND

1. Field

Disclosed are systems and methods related to digital media playback systems, and more particularly to media playback systems having distributed elements.

2. Related Art

Digital media storage and playback systems have become increasingly common. In many instances, there are multiple devices involved in enjoying media such as music or videos. A server device may store the content of the media and include a display for viewing and speakers for listening to music. A wireless device may communicate and control the server for management of the performance of the media. When such an integrated system is employed to enjoy media, what is desirable is an improved manner in which to synchronize a status of real time performance of media between such devices.

### SUMMARY

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Aspects include an audio/visual (A/V) content performance system allowing remote viewing of status information on a variety of status display devices. The system can comprise an A/V content performance device operable for performing A/V content accessible from the content performance device, and a wireless network to which the performance device is operable to connect. The system comprises a status display device operable to interface with the wireless network, and initiate a request to the performance device, transmitted through the network, for status information concerning A/V content currently being performed. The performance device is operable to respond with update messages upon status changes during content performance, where the update messages convey information describing one or more changes to content playback status.

Other aspects include a method for obtaining A/V playback status at a remote device. The method can comprise requesting from an A/V performance device an indication when a real-time play status of A/V content being performed changed, and receiving the indication at a remote device over a wireless network. The method also comprises requesting, from the remote device, updated status information, receiving updated status information at the remote device, and interpreting the status information. The remote device implements one or more changes to a display at the remote device based on the interpreted status information.

In another aspect, a method applies in a network where a remote content performance or content control device communicates with a server that provides the content and/or updates of the content. The remote device sends a message to the server indicating that it is at status X and requests notification when the status has changed. X can represent any assigned status number. For example, if a user is listening to a song in a playlist, the status may be status 3 representing that the system has changed from a first status, to a second status and is now on a third status. Any status changes such as pausing, updated metadata, new images, and so forth can trigger a status change. The server receives the message but does not act on the request until a status change exists. For example, if a song ends and a new song is to begin, the status change may be incremented to status 4. The server can either simply notify the remote device of the status change at which point the remote device sends another request for the update content associated with the new status or the server may simply send the new content with instructions that that the new contents is associated with status 4. At this point, the remote device transmits another message and request that it is at status 4 and to notify the remote device when the status changes. In this manner, real-time updated information can be maintained between the server and the remote device. The remote device may perform the content or may also be a remote control for the server device to perform the content.

Still other aspects include a computer readable medium storing computer readable instructions for a method implementable in an A/V performance system. The method comprises receiving, from a remote device, a request for updates to content playback status. The request including a version number indicating status information current at the remote device. The method also comprises implementing a content playback status change, sending to the remote device an indication that the content playback status was updated, and fulfilling a request from the remote device for the updated status with information describing the updated status and an incremented version number. The method also comprises continuing with the receiving of another request for updates to content playback status. The request can include the incremented version number.

### BRIEF DESCRIPTION OF THE DRAWINGS

FIG. 1 illustrates an example system architecture for a A/V system having a A/V performance device coupled to a wireless network, which also communicates with a plurality of remote status display devices;

FIG. 2 illustrates example components that may be used in implementing remote display devices, and other systems or system elements according to present examples;

FIGS. 3 and 4 illustrate examples of signal flows for illustrating aspects of status display synchronization.

FIG. 5 illustrates steps of a method performable by a performance device to communicate status update information to a remote status display device;

FIG. 6 illustrates steps of a method performable by a remote status display device to obtain status updates from the performance device; and

FIGS. 7-9 illustrate examples of how status information can be interpreted by a remote status display device to effect changes to a display by the device of status information.

### DESCRIPTION

The following description is presented to enable any person skilled in the art to make and use an A/V content playback system including a source of A/V content, and one or more remotely situated devices on which status can be viewed by one or more users. Various modifications will be readily apparent to those skilled in the art based on the disclosures here, and principles defined herein may be applied to other embodiments and applications without departing from the spirit and scope of the invention. Moreover, in the following description, numerous details are set forth for the purpose of explanation. However, one of ordinary skill in the art will realize from these disclosures that the invention might be practiced without the use of these specific details. In other instances, structures and processes are shown in block diagram form in order not to obscure the description of the invention with unnecessary detail. Thus, embodiments of the present invention are not to be limited to the examples shown, but encompass the widest scope consistent with the claims appended hereto.

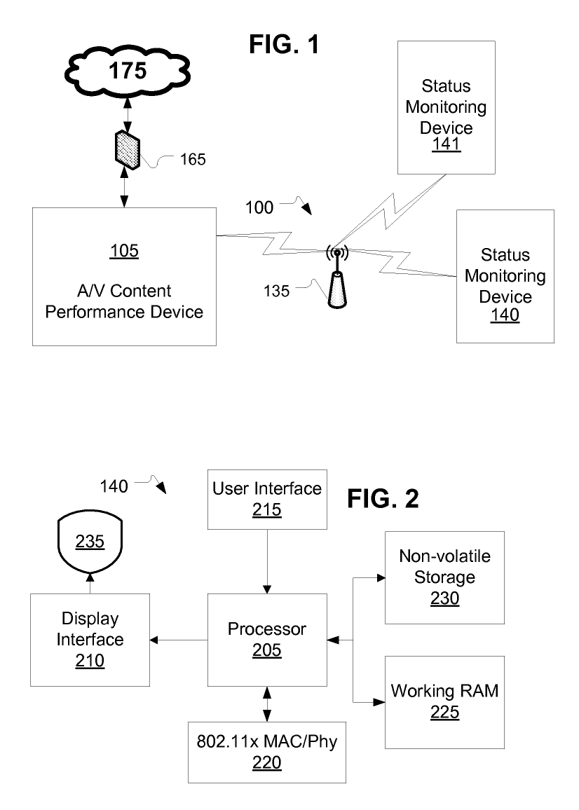

FIG. 1 illustrates aspects of a system 100 including an A/V content performance device that may be implemented using a personal computer, such as an HP Pavilion, iMac™, Dell Vostro, or a Macbook Pro, configured for running a A/V content distribution and storage program, such as iTunes. Device 105 also may be implemented as a dedicated hardware device running built in, firmware, and/or software-defined functionality, such as an Apple TV device. Device 105 may access Internet 175 through a firewall 165 for obtaining downloadable and/or streaming media content from any of a variety of sources, such as web sites allowing user-posted video, including YouTube, digital radio stations, and so on. Device 105 also may have access to reception of over-the-air HDTV broadcasts through a suitable antenna, as well as radio broadcasts in the FM spectrum. Device 105 also may accept inputs from DVD players, CD players, Blu-Ray players, video game consoles, and other sources of A/V content. Thus, device 105 functions as an aggregator and storage facility for A/V content that can be made available to nodes where such content can be performed. Such nodes can be located remotely from device 105, such that the content can be transmitted via a wired or wireless network, or locally situated with content transmission via one or more direct cable connections (e.g., an HDMI or optical link, and so on.)

Device 105 also communicates with a wireless access point 135, which can operate according to one or more 802.11x series protocols (e.g., 802.11g, 802.11n, and so on). Device 105 may contain an add-in card, or have an integrated MAC/PHY to enable such communication.

Device 105 provides storage for a media library that can be associated with a library manager such as iTunes; media libraries also can be accessed through wireless network 135, or by any other network to which device 105 has access. These libraries can provide content accessible to and through device 105 without any explicit interaction on the part of a user to determine in what physical location a particular item of content may be. Content can be downloaded and stored at (more broadly, locally accessible to) device 105, and device 105 also can obtain streams of content from Internet-based hosts.

Devices 140 and 141, e.g., a phone, smartphone, personal information manager, Blackberry™ or an iPhone™, also are equipped with an 802.11 MAC/PHY, for communicating with access point 135. Devices 140 and 141 can be implemented by a phone or other portable electronic device having a capability of being equipped/programmed with software/firmware enabling functionality according to examples in the following description. In addition to being able to provide status information to user(s) of devices 140 and 141, these devices also can accept status change request information from users and provide those requests to device 105; however, the present description focuses more on status updates than use of devices 140 and 141 as remote controls to device 105 or to performance nodes receiving content from device 105.

In sum, system 100 includes a device 105 capable of providing A/V content stored in media accessible to device 105 to nodes for performing such content. System 100 also includes one or more status reviewing devices 140 and 141 to which playback status can be synchronized and from what updates or changes to playback-related properties can be requested, as explained further below.

FIG. 2 illustrates further implementation details concerning potential embodiments of phone 140, which can be configured to function as a remote control for A/V performance nodes. As shown in FIG. 2, device 140 includes a processor 205, which is coupled to receive user interface 215 inputs, produce visual output to display interface 210, which in turn uses such visual output to drive display 235. Processor 205 also is operable to read and write data from working RAM 225, and non-volatile storage 230, such as flash memory, and the like. Processor 205 also is coupled for sending and receiving data over a wireless network using 802.11x MAC/PHY 220. Processor 205 can be configured to execute programs specified by computer readable instructions stored in non-volatile storage 230 and/or in working RAM 225, or received over MAC/PHY 220.

The constituent components and arrangement of same in FIG. 2 can differ in implementations. For example, non-volatile storage may function as a working RAM for certain applications. As memory technology advances, a notion of maintaining separate RAM and non-volatile memory in portable devices may largely recede. Non-volatile memory also can be a hard drive or another kind of magnetic or optical storage. The components shown in FIG. 2 also can be integrated; for example, processor 205 can be an ARM core formed with MAC/PHY 220 (or the MAC only, with discrete magnetics, etc.), and some or all of RAM 225. As such, it would be understood that a variety of devices implemented in any number of ways can be used as a status display device 140 in system 100 (FIG. 1).

FIG. 2 also can represent example components of device 105 (e.g., a computer), except that certain components generally would be more full-featured in device 105. For example, processor 205 would be more powerful, and non-volatile storage 230 would be larger. User interfaces may include larger keyboards, separate mice, and so on. Display 235 may be larger, and there may be a more power discrete graphics processor interfacing with processor 205 for driving display 235.

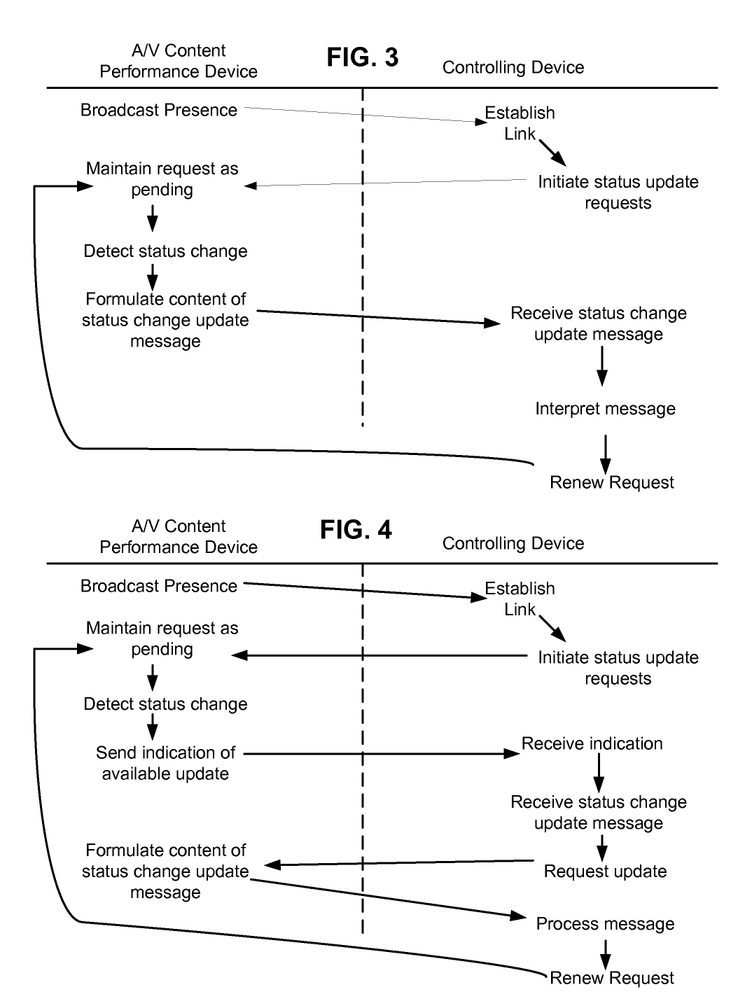

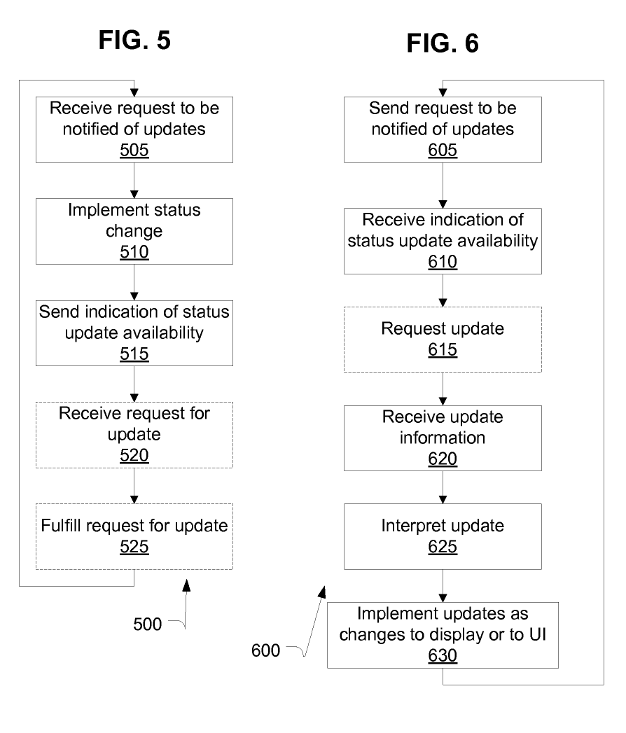

FIG. 3 and FIG. 4 illustrates example data exchange that can occur by passing messages that may be embodied on signals or in computer readable media accessible by device 105 and controlling devices 140 and/or 141. These data exchanges can be in accordance with steps from example methods discussed with respect FIGS. 5 and 6.

In FIG. 3, an A/V content performance device (e.g., a computer running a content library manager), through a wireless network broadcasts its presence. A status display device can receive the presence broadcast and establishes a link with the performance device, and initiates a status update request, which is sent to the performance device. This status update request can be formatted as an HTTP request (e.g., that it is encapsulated within a standardized HTTP format document, although content of the request need not be parseable markup language, or even be in alphanumeric characters).

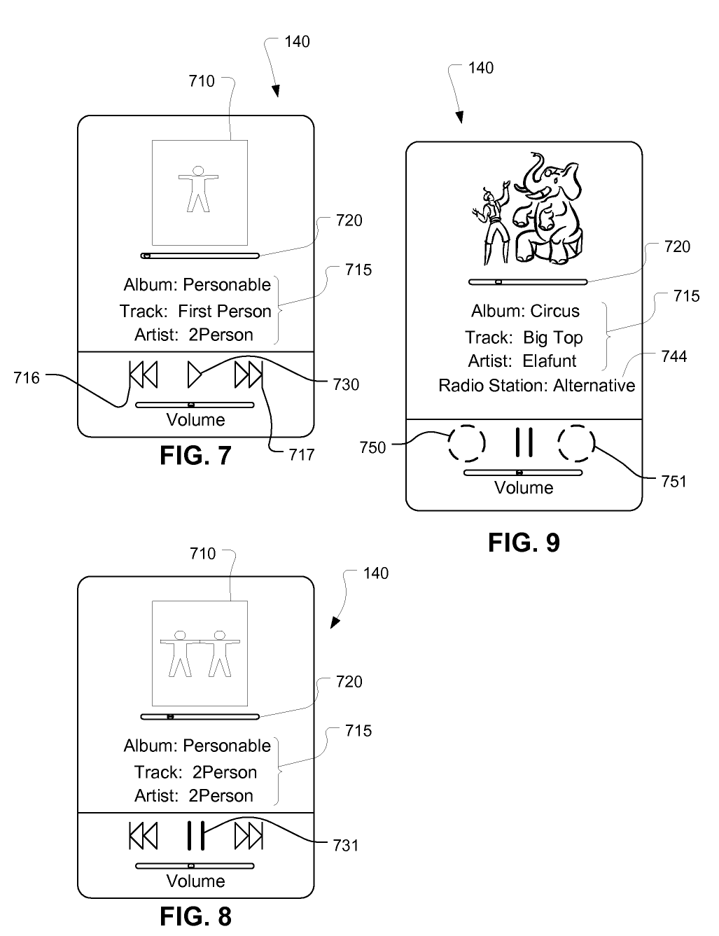

The performance device, having received the request from the controlling device to be informed of status updates, maintains an indicator that such a request is outstanding. When a status change is detected by the performance device, it can formulate a status change update message and send that message to the controlling device. The controlling device receives the update message, and interprets the contents of it, as explained in further detail with respect to the examples of FIGS. 7-9. Then, the controlling device renews its request to be informed of status updates, and the signal flow can repeat.

FIG. 3 thus illustrates a signal flow where an outstanding update request is serviced upon detection of a status change update. FIG. 4 illustrates a variation, where a status change update can be used as a trigger to send an indication that a status change update is available. The controlling device then can request information about the status change update, and in response to that request the status change information can be provided.

Systems also can implement a hybrid of the signal flows of FIG. 3 and FIG. 4 in that some parts of a given update may be transmitted upon detection/implementation (FIG. 3), while other parts may be pulled by the controlling device, after receiving an indication of availability (FIG. 4). For example, binary status information may be provided according to FIG. 3, while updated graphical information may be pulled. In either case, the controlling device ultimately receives one or more update messages having information descriptive of status changes (which can include a broad range of information, as described in further detail below).

The information can be described from a context of a change to a previous status known to the controlling device (e.g., transmitting only change increments, where appropriate). However, since an amount of information required to completely describe the status generally is not large, it can be more convenient simply to retransmit all status information when any status aspect changes. Also, some status information is not amenable to incremental updating, such as track and album names. In cases where larger amounts of information, e.g., graphics, are involved, then those graphics can be transmitted only when they change, and other less data intensive status information can be retransmitted on every status change.

FIG. 5 illustrates a method 500 implementable by a content performance device 105, such as device 105 (FIG. 1). Method 500 includes receiving a request to be notified of status updates (505). As shown in FIG. 6, this request can come from a controlling device (e.g., device 140), in a step 605 of a method 600 being implemented by device 140. During operation, device 105 implements 510 a status change. For example, referring to FIG. 7, a user interface is shown as displaying a time remaining indicator 720, which shows that the present album track (identified in biographical information 715). So, a status change that can be implemented by device 105 can include changing album artwork 710, and biographical information 715 at the start of a new track being performed by device 105.

The example discussed with respect to FIG. 5 generally conforms to a situation where performance device 105 would be considered a server of content, and would take status change requests from devices via request mechanism, implement such changes and then confirm implementation. In a different example, status change functionality implemented in devices receiving status change information also can be more directly involved in implementing (as opposed to simply reporting) status changes. In such an example, status change information can be sent from device 140 to device 105. For example, user input can indicate pausing the performance on device 140 shown in FIG. 7. In this different scenario, device 140 can transmit information to the performance device 105 that its status has changed from status 3 to status 4 and what the status change is (or any suitable representative of sequential status versions), based on the pausing step. The performance device 105 can then act on that status change by pausing the performance and incrementing its status from 3 to status 4. Performance device 105 then can confirm that the status change was implemented in a message to device 140. Device 140 can update its visual display in response to the confirmed status change, or in response to a user inputting the status change, thereby indicating that playback now is paused.

Returning now to FIG. 5, method 500 also includes sending a respective indication to devices that requested status update notification that status updates are available (515). For example, in FIG. 1, it was shown that both devices 140 and 141 can communicate wirelessly through base station 135 to content performance device 105, both registering their request to receive status updates.

Depending on whether there is being implemented a signal flow according to FIG. 3 or to FIG. 4, the indication transmitted at 515 may or may not contain status update information itself. As described with respect to FIG. 3, upon detection of available status updates, device 105 can message those updates to devices requesting such updates. As such, the indication at 515 can contain status information in implementations according to that example.

Where a signal flow according to FIG. 4 is implemented (ignoring a hybrid situation for the sake of clarity), device 140 receives the indication and forms an update request message (610) transmitted (615) to device 105 (shown as a dashed box to indicate optional in view of implementing according to the signal flow of FIG. 3).

Then, method 500, if implementing a signal flow according to FIG. 4, would receive the request to obtain the updates (520) and fulfill that request (525) with one or more messages containing information descriptive of the updates. Steps 520 and 525 are shown in dashed boxes also to indicate that depending on implementation, these steps may or may not be taken.

In either case, method 600 includes receiving, at device 140 (and any other device requesting such updates) the update information (620), interpreting that update information (625), and implementing updates/changes according to the interpretation of the update information (630).

Interpreting 625 and implementing 630 can include using raw status or capabilities information or other information to effect UI changes or display changes, as described further with respect to FIGS. 7-9. For example, a play indicator 730 is illustrated in FIG. 7. Status information transmitted may include a play/pause status bit in a group of bits; however, it is up to device 140 to determine how to render a visible indication of such status for a user. For example, a graphical implementation of play indicator 730 can vary among devices, or among available configurations for a given device. So, a device itself should have control over what changes are made locally based on received information.

For example, Table 1 below shows information types that can be transmitted in status update messages. For example, play status can be a binary value indicating either play (1) or pause (0) (or vice versa). Likewise, support for shuffle capability or repeat capability can be indicated by respective bits, as each is either supported or not for a given item of content. For example, if an Internet-based source of content is currently being accessed, then the shuffle bit may indicate that shuffle is not presently supported. Other data can include string variables or number variables, as illustrated. Various formats for numbers can be supported, for example, total track time, and time remaining each can have separate number fields representing minutes and seconds. All such information preferably is transmitted in a pre-arranged binary format, although in other implementations, more human readable or interpretable formats can be used. For example, XML tags can be used to identify data fields, followed by values for such fields. In some cases, multiple formats can be pre-arranged, and an indication of a format for a particular message can be included with that message. Other types of messages that can be supported include system messages that can provide for updating of such formats.

TABLE 1

| | | | Total | | | | | | | | |
|---|---|---|---|---|---|---|---|---|---|---|---|
| Play | | | Track | Time | | | | | Next | Next | Next |
| Status | Shuffle | Repeat | Time | Remaining | Artist | Album | Track | Rating | artist | album | track |
| Bit | Bit | Bit | # | # | String | String | String | # | String | String | String |

Now returning to further examples of how a device receiving status update messages can interpret content in those messages, FIG. 8 and FIG. 9 illustrate examples where a number of status elements were changed with respect to FIG. 7, including album artwork 710, and album biographical information 715. Also, play status 731 also now indicates to a user that the play status is paused. As FIG. 8 illustrates an example of a display viewable by a user, the display shown reflects message content received in one or more status update messages.

FIG. 9 illustrates an example where a status display includes a radio station indication 744, allowing a user from that device to see such source information. Also depicted is that the display currently does not show track back 716 and forward 717 navigation arrows (FIG. 7). The lack of these arrows can be in response to receiving an update message that the present content origin (i.e., the radio station) does not support track back/forward functionality. Thus, in response, the device 140 (i.e., the device having the displays illustrated in FIGS. 7-9) would hide those arrows, as they would have no present effect with respect to the content currently being performed.

Also apparent from the above disclosures is that device 105 provides update aggregation functionality, such that there can be multiple ways that control requests can be made or status changes can be requested or caused. For example, as described above, new content information can come from a radio station changing tracks, or album art work. By further example, commands can come from a first remote control indicating a control request, e.g., pause, skip, shuffle, or repeat a given item of A/V content. Each of inputs can be a source of/cause initiation of a status change at device 105 (i.e., controlling device 105 to change status), which in turn causes production and transmission of status update messages that can be provided to a plurality of status reviewing devices, which have made requests to receive such status update messages. Thus, status reviewing devices (e.g., device 140) also can function as sources of control requests to device 105, such that those devices also can function as remote controls, if appropriately configured. For example, a personal information manager, a laptop computer, a smartphone, an iPhone, and a Blackberry all can function as a device for receiving status updates effected from any or all of these sources.

In the above examples, various functionality and capabilities were attributed to computer 105, and such capabilities can be readily implemented by computer readable instructions stored in a computer readable medium available to a computer having one or more processing resources for executing such instructions.

Similarly, an example of a phone configured for software for communicating with computer 105, and providing user interface screens for obtaining user input concerning properties updates to A/V performance nodes was illustrated. However, a person of ordinary skill also would be able to understand based on these disclosures that other devices having wireless networking capability, and which can be programmed or otherwise configured to obtain property information from an A/V source concerning one or more remote A/V performance nodes, solicit user inputs for updating such properties, and communicate such updates to the A/V source can be used as a remote controller in accordance with these examples.

For sake of clarity, certain functionality and/or other capabilities were attributed to specific portions of a device, in some cases. However, such attribution does not imply a requirement that such functionality be implemented in that device portion, but rather as technological innovation continues variations on implementations of devices would be expected by those of ordinary skill based on these examples. For example, those of ordinary skill can make decisions concerning whether to implement a given function in hardware or as software configuring a processor, whether to use multiple different processors in a given system, one larger processor, and so on.

In another embodiment, the focus is on the server device 105 and the communication to and from that device. An example method aspect of this embodiment includes a method for synchronizing media playback status between the server device 105 and a client device 141, 140. The method includes, at the server device, receiving data from the client device 141, 140 indicating its status associated with real-time media playback and a request for notification for a change in status of the real-time media playback and waiting to act upon the received data until a change in the status of the real-time media playback exists. Upon the change in the status of the real-time media playback (which can be any change such as a new song, new movie, updated images, updated metadata provided in the middle of the performance, etc), either (1) sending an incremented status notification to the client device with data associated with the changed status or (2) sending notification to the client device of a change in status, receiving a request from the client device for the new status and transmitting the incremented status notification to the client device with data associated with the changed status.

Yet another embodiment is client device based and focuses on communications to and from the client device or remote device. An example method includes a method for synchronizing media playback status between a server device 105 and the client device 141, 140. The method includes, at the client device, transmitting data to the server device indicating a status of the client device associated with real-time media playback and a request for notification for a change in status of the real-time media playback, wherein the server device waits to act upon the received data until a change in the status of the real-time media playback exists. Upon the change in the status of the real-time media playback, either (1) receiving an incremented status notification from the server device with data associated with the changed status or (2) receiving notification from the server device of a change in status, transmitting a request from the client device for the new status and receiving the incremented status notification to the client device with data associated with the changed status.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. A “tangible” computer-readable medium expressly excludes software per se (not stored on a tangible medium) and a wireless, air interface. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps. Program modules may also comprise any tangible computer-readable medium in connection with the various hardware computer components disclosed herein, when operating to perform a particular function based on the instructions of the program contained in the medium.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Although the above description may contain specific details, they should not be construed as limiting the claims in any way. Other configurations of the described embodiments of the invention are part of the scope of this invention. Accordingly, the appended claims and their legal equivalents should only define the invention, rather than any specific examples given.

We claim:

1. A remote updating a media content system, comprising:
a content performance device operable for performing content accessible from the content performance device;
a wireless network to which the performance device is operable to connect; and
a status display device operable to interface with the wireless network, and initiate a request to the performance device, transmitted through the network, for status information concerning content currently being performed, and wherein the performance device is operable to respond with update messages upon status changes during content performance, the update messages conveying information describing one or more changes to content playback status.

2. The remote updating the content system of claim 1, wherein the status display device also is operable as a remote control for the content performance device.

3. The remote updating content system of claim 1, wherein the content performance device includes a computer configured with media library software.

4. The remote updating content system of claim 1, wherein the content performance device includes a computer operable to communicate using the network.

5. The remote updating content system of claim 4, wherein the computer is further operable to operable to obtain content over the Internet, and changes in such content can initiate status changes.

6. The remote updating content system of claim 1, further comprising a remote controller device, operable to effect a status change to content currently being performed, the status change being received by the performance device, which responsively generates an update message for the status display device.

7. A method for obtaining content playback status at a remote device, comprising:
requesting from a content performance device an indication when a real-time play status of content being performed changed;
receiving the indication at a remote device over a wireless network;
requesting, from the remote device, updated status information;
receiving updated status information at the remote device;
interpreting the status information; and
implementing one or more changes to a display at the remote device based on the interpreted status information.

8. The method of claim 7, wherein the request for the indication is formed as an HTTP request.

9. The method of claim 7, wherein the request for the indication is formed as an HTTP request, and the updated status information received at the remote device includes binary data encapsulated in an HTTP response.

10. The method of claim 7, wherein the updated status information includes properties information about media currently being performed, and the one or more display changes implemented include showing or hiding one or more controls based on the properties information.

11. The method of claim 10, wherein the one or more controls includes a shuffle control and a repeat control.

12. The method of claim 7, wherein the updated status information includes an indication that shuffle control is not available for streaming media.

13. The method of claim 7, wherein the updated status information includes a time remaining for a particular item of content being performed.

14. The method of claim 7, wherein the updated status information includes a version number for the update information.

15. The method of claim 7, wherein the updated status information includes an indication that shuffle control is not available for streaming media.

16. The method of claim 7, wherein the indication includes information that album artwork has been updated, and the updated status information includes the updated album artwork.

17. The method of claim 7, wherein the remote device renews its request for an indication of updated status information after the receiving of the updated status information.

18. The method of claim 7, wherein the updated status information includes supported capability information, and the interpreting includes determining how to present availability of the supported capabilities to a user of the remote device.

19. The method of claim 7, further comprising sending from the remote device to the performance device data indicative of a control request by a user at the remote device, wherein the remote device receives updated status information if the control request update was implemented by the performance device, and the remote device updates displayed status information responsive to the updated status information received from the performance device.

20. A computer readable medium storing computer readable instructions for a method implementable in a content performance system, comprising:
receiving, from a remote device, a request for updates to content playback status, the request including a version number indicating status information current at the remote device;
implementing a content playback status change;
sending to the remote device an indication that the content playback status was updated;
fulfilling a request from the remote device for the updated status with information describing the updated status and an incremented version number; and
continuing with the receiving of another request for updates to content playback status, the request then including the incremented version number.

21. The computer readable medium of claim 20, wherein the method further comprises receiving from another remote control another request for updates, and also sending to the additional remote control updated status information.

22. The computer readable medium of claim 20, wherein the method further comprises receiving from an Internet-based content source updated status information, and sending the updated status information to the remote device.

23. The computer readable medium of claim 20, wherein the method further comprises sending, as updated status information, information relating to how a particular item of content can be controlled by the remote device.

24. The computer readable medium of claim 23, wherein the information about how the item of content can be controlled includes information about one or more of whether the content is skippable, or repeatable.

25. The computer readable medium of claim 23, wherein the information about how the item of content can be controlled includes information about a rating of the item of content.

26. The computer readable medium of claim 23, wherein the item of content is part of a content stream, and the information about how the item of content also contains information pertinent to the content stream.

27. The computer readable medium of claim 20, wherein the method further comprises receiving a request to update a property associated with the content playback status, implementing the request, and sending updated status information to the remote device for that update.

28. A method for synchronizing media playback status between a server device and a client device, the method comprising, at the server device:
receiving data from a client device indicating its status associated with real-time media playback and a request for notification for a change in status of the real-time media playback;
waiting to act upon the received data until a change in the status of the real-time media playback exists; and
upon the change in the status of the real-time media playback, either (1) sending an incremented status notification to the client device with data associated with the changed status or (2) sending notification to the client device of a change in status, receiving a request from the client device for the new status and transmitting the incremented status notification to the client device with data associated with the changed status.

29. A method for synchronizing media playback status between a server device and a client device, the method comprising, at the client device:
transmitting data to the server device indicating a status of the client device associated with real-time media playback and a request for notification for a change in status of the real-time media playback, wherein the server device waits to act upon the received data until a change in the status of the real-time media playback exists; and
upon the change in the status of the real-time media playback, either (1) receiving an incremented status notification from the server device with data associated with the changed status or (2) receiving notification from the server device of a change in status, transmitting a request from the client device for the new status and receiving the incremented status notification to the client device with data associated with the changed status.
